(19) United States
(12) Patent Application Publication
(10) Pub. No.: US 2013/0141780 A1
(43) Pub. Date: Jun. 6, 2013

(54) System And Method For Tri-state Electro-optical Displays

(71) Applicants: Yoocharn Jeon, Palo Alto, CA (US); Richard H. Henze, San Carlos, CA (US); Jong-Souk Yeo, Corvallis, OR (US); Gary Gibson, Palo Alto, CA (US); Jeffrey Todd Mabeck, Corvallis, OR (US); Pavel Kornilovich, Corvallis, OR (US); Gregg Alan Combs, Monmouth, OR (US); Zhang-Lin Zhou, Palo Alto, CA (US)

(72) Inventors: Yoocharn Jeon, Palo Alto, CA (US); Richard H. Henze, San Carlos, CA (US); Jong-Souk Yeo, Corvallis, OR (US); Gary Gibson, Palo Alto, CA (US); Jeffrey Todd Mabeck, Corvallis, OR (US); Pavel Kornilovich, Corvallis, OR (US); Gregg Alan Combs, Monmouth, OR (US); Zhang-Lin Zhou, Palo Alto, CA (US)

(21) Appl. No.: 13/816,116

(22) PCT Filed: Aug. 9, 2010
(86) PCT No.: PCT/US10/44870

§ 371 Date: Feb. 8, 2013

(51) Int. Cl. G02F 1/167

(52) U.S. Cl. CPC G02F 1/167
USPC 359/296

(57) ABSTRACT

There is provided a display including a display including a number of display cells (400). Each of the display cells (400) includes a first electrode (414), which is transparent and disposed over a front surface of a display cell (400). A second electrode (418) is disposed opposite the first electrode (414). A dielectric layer (404) is disposed between the first electrode (414) and the second electrode (418), and is patterned to create a plurality of recessed volumes (408). A fluid is disposed in a volume defined by the first electrode (414), the dielectric layer (404), and the recessed volumes (408). The fluid (410) comprises a dye of a different color from an adjacent display cell (400). Charged particles (412) are disposed within the fluid (410). The display also includes a display driver configured to pack the charged particles (412) against the front of the display cell to create a first optical state, to pack the charged particles (412) against the back of the display cell (400) to create a second optical state, or to pack the particles into the recessed regions (408) to create a third optical state.

### BACKGROUND

Display technologies have significantly advanced from the cathode ray tube (CRT) technology used for computer displays in the past. Newer displays, such as those based on liquid crystals, are lighter, and can often have much higher resolution than the early displays. More recently, even lighter, lower power displays based on moving electrically charged particles have been developed. These displays may be termed electronic ink displays. The characteristics of electronic ink displays, such as low power demand and easy readability, have made new types of applications practical.

### BRIEF DESCRIPTION OF THE DRAWINGS

Certain exemplary embodiments are described in the following detailed description and in reference to the drawings, in which:

FIG. 1 is a electronic display device, in accordance with an embodiment of the present techniques;

FIG. 2 is a magnified view of a portion of the electro-optical display of FIG. 1, in accordance with an embodiment of the present techniques;

FIG. 3 is a magnified top view of a single display cell, in accordance with an embodiment of the present techniques;

FIG. 4 is a cross section of a three electrode display cell showing the individual components that may be used in the display cell, in accordance with embodiment s of the present techniques;

FIG. 5 is a cross section of a two electrode display cell showing the individual components that may be used in the display cell, in accordance with embodiments of the present techniques;

FIG. 6 is a schematic showing three states of operation of a three-electrode display cell, in accordance to an embodiment of the present techniques;

FIG. 7 is a schematic showing three states of operation of a two-electrode display cell, in accordance to an embodiment of the present techniques;

FIG. 8 is a graph illustrating the use of a dielectric switching layer that may be used to drive a display cell in accordance with an embodiment of the present techniques;

FIG. 9 is a schematic of a pixel in which each of three adjoining display cells functions as a sub-pixel in the pixel, in accordance to an embodiment of the present techniques:

FIG. 10 is a mobile phone having a skin, or surface display, which uses three state display cells, in accordance with embodiments of the present techniques;

FIG. 11 is a sign that uses display cells to display information on a background, in accordance with an embodiment of the present techniques;

FIG. 12 is an illustration of a segmented display which uses display cells as the segments, in accordance with an embodiment of the present techniques;

FIG. 13 is a shelf pricing tag that may be made of display cells, in accordance with an embodiment of the present techniques; and

FIG. 14 is a block diagram of an electronic device that uses an electro-optical display made of display cells, in accordance with embodiments of the present techniques.

### DETAILED DESCRIPTION OF SPECIFIC EMBODIMENTS

Embodiments of the present techniques provide a display cell that has three primary states of operation based on the position of particles in the display cell. In a first optical state, the display cell may display a white color, for example, when white particles are at the front of the cell. In a second optical state, the display cell may display a color, for example, when the particles are at the back of a cell, allowing a colored fluid to show. In a third optical state, the display cell may display a background color, such as black, when the particles have been packed in small recessed volumes.

The display cells may be used to form one type of electro-optical display, which may be termed an electronic ink display. As an electro-optical display may not generate light to produce an image, it may have lower power usage than many other technologies, including, for example, light emitting diode (LED) displays, organic light emitting diode (OLED) displays, or liquid crystal displays (LCDs). However, the use of reflected ambient light to form an image may cause the electronic ink display to be dim. In past color electronic ink displays, white was generated by combining reflected light, for example, from three primary colors making up layers in the display or through the use of color filters over black and white display cells. In an embodiment, the display cell and applications discussed herein may overcome this difficulty by directly reflecting white light from particles that are located at the front of the display.

In an embodiment, the particles are moved by applying voltages to three electrodes in the display cell. A first, transparent electrode is located over a first volume at the front of the display cell. A second electrode can be located at the back of the first volume. The second electrode may be colored, for example, black, and can be visible when particles are collected in the recessed volumes, for example, located at the back of the cell. As noted herein, the second electrode can also be transparent and have a dark or black absorber layer underneath. A third set of electrodes may be located at the back of the recessed volumes that protrude from the first volume, for example, through the second electrode. The display cell is not limited to three electrodes, as embodiments that use two electrodes may be used to generate all three primary display states, as discussed below. The display can be incorporated into any number of electronic devices.

In either a two electrode configuration or a three electrode configuration, the voltages may be set to a first level to create an electric field between various electrodes that may be used move the particles to the front of the cell or to the back of the cell, for example, by electrophoresis. Further, a different set of voltages may be applied to the same or different electrodes to move the particles by an electrical current flow through the display cell, for example, to move the particles into the recessed volumes.

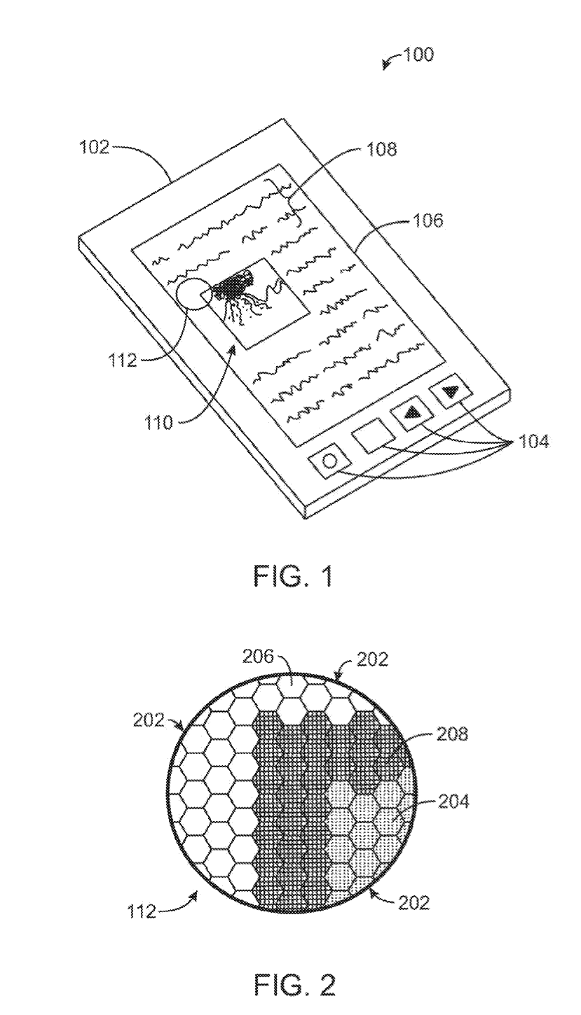

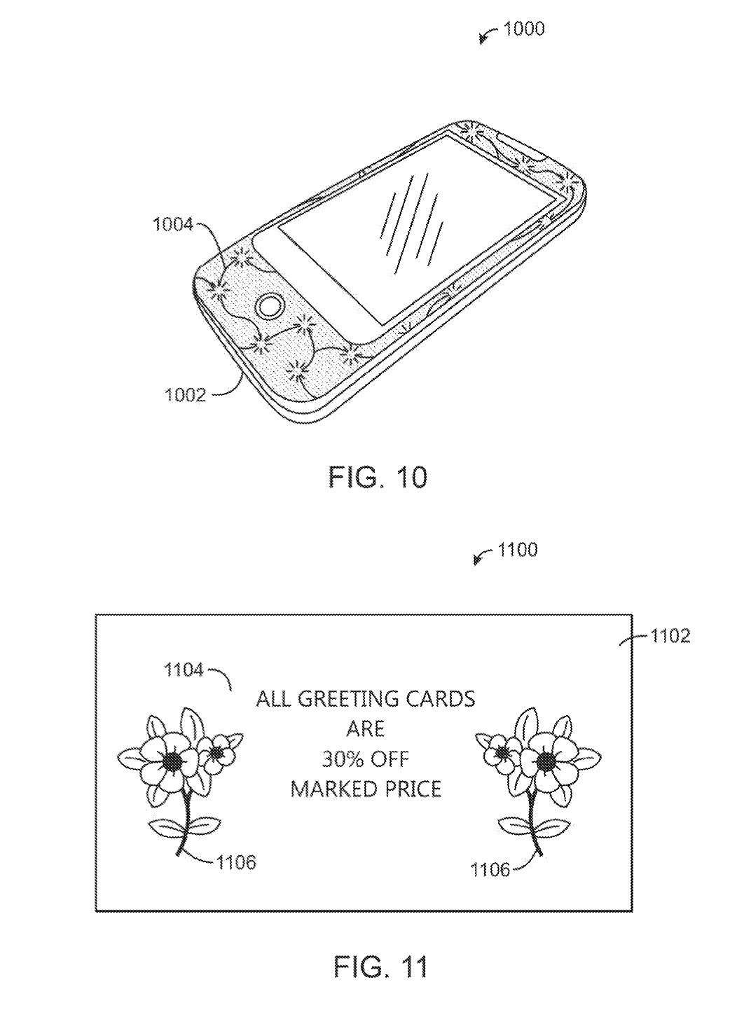

The display cell may be used in any number of applications. For example, the display cell may be used as a pixel or a sub-pixel in a pixelated display, as discussed with respect to FIG. 1. In other embodiments, the display cell may be a single display element in a sign or segmented display, as discussed with respect to FIGS. 10-14. The display may be more clearly explained by examining an exemplary application, as shown in FIG. 1.

FIG. 1 is an electronic display device 100, in accordance with an embodiment of the present techniques. The electronic display device 100 may have a case 102 that may be made from plastic, metal, or other material. The case 102 may hold a number of buttons 104 that can be used to control the electronic display device 100, for example, selecting a publication, turning a page, or opening a connection to a server. In an embodiment, the electronic display device 100 may have an electro-optical display 106 that uses the display cells operated in the display states described herein. The display cells may have multiple states that allow the electro-optical display 106 to display high-contrast text 108 and images 110 clearly. A magnified view 112 of a portion of the electro-optical display 106 is shown in FIG. 2.

FIG. 2 is a magnified view 112 of a portion of the electro-optical display 106 of FIG. 1, in accordance with an embodiment of the present techniques. In the magnified view 112, individual pixels 202 are shown. Each pixel 202 can include one or more display cells that may act as sub-pixels to allow the pixel 202 to display different colors, as described herein. Although the pixels 202 are shown as hexagons, they may be any appropriate shape, including squares, circles, and the like. The pixels 202 may be a shape that allows tessellation of pixels 202, such as a square, rectangle, triangle, or hexagon (as shown). The multiple states of the pixels 202 are shown in the magnified view 112, in which a first group of the pixels 204 are displaying a color, a second group of the pixels 206 are displaying white, and a third group of the pixels 208 are displaying black.

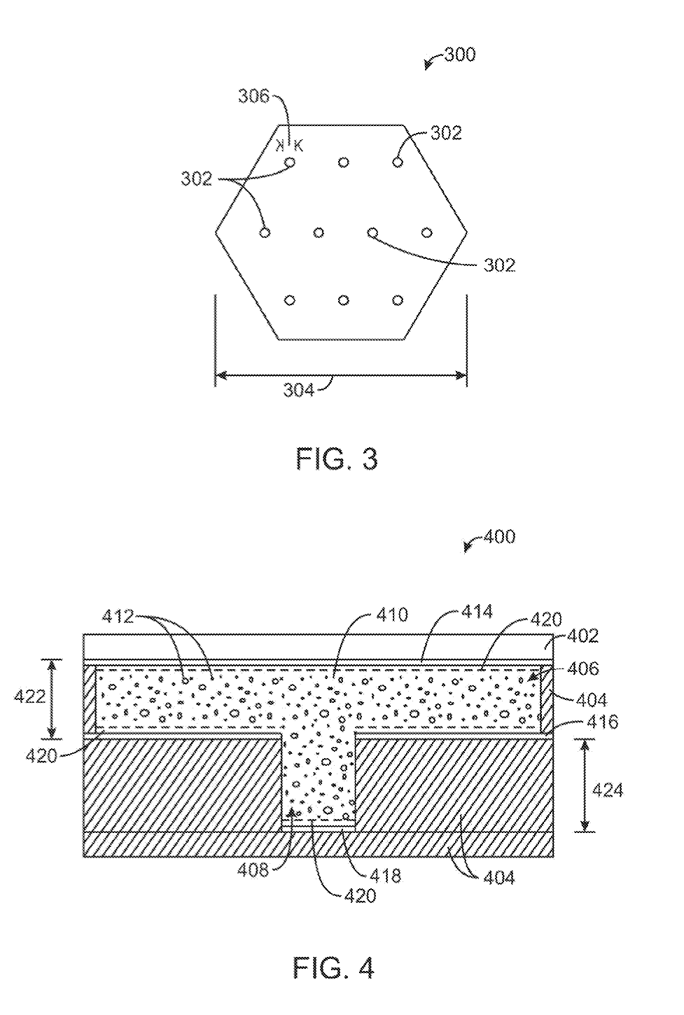

FIG. 3 is a magnified top view of a single display cell 300, in accordance with an embodiment of the present techniques. The display cell 300 may have recessed volumes 302. The recessed volumes 302 may be used to hold reflective particles, allowing a background, such as a dark surface or light absorbing material to be visible. As shown in FIG. 3, a number of the recessed volumes 302 may be used in the display cell 300, in order to reduce the distance a particle may have to travel to enter a recessed volume 302. This may improve the switching speed of the display cell 300. The recessed volumes 302 may have a low aperture or visible cross section in relation to the entire area, to reduce the impact of the particles in the recessed volumes 302 on the overall color. For example, in an embodiment, the width 304 of the display cell may be about 50-500 μm. By comparison, the recessed volumes 302 may have a diameter 306 of about 2-20 μm and, thus, may not substantially affect the optical contrast of the display cell 300. The display cells 300 are not limited to these dimensions, as any number of sizes may be used. In general, the recessed volumes need to have a combined volume large enough to accommodate all the reflective particles present in the display cell 300. Further, in other applications, such as segmented displays, a pixel 202 (FIG. 2) or a display cell 300 may be as large as a single segment or a single graphical area, such as a letter or word. However, the display cells 300 will often be smaller to reduce the settling of particles.

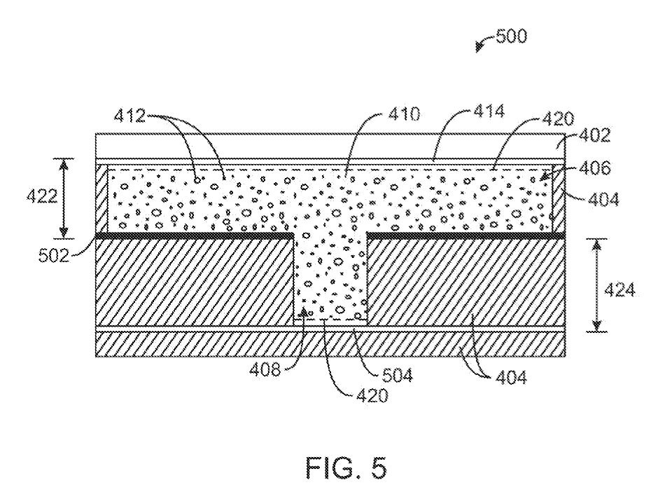

FIG. 4 is a cross section of a three-electrode display cell 400 showing the individual components that may be used in the display cell 400, in accordance with embodiments of the present techniques. The display cell 400 is covered by a transparent layer 402 over the front surface of the display cell, which protects the display cell 400 and allows light to impinge on the display cell 400. The transparent layer 402 may be any transparent, non-conducting material, such as plastic, glass, or a clear mineral. For example, the transparent layer 402 may include acrylic, polystyrene, polycarbonate, polyethylene terephthalate, fused quartz, soda-lime glass, sapphire, or any suitable clear material. A dielectric material 404, such as polytetrafluoroethylene (PTFE), negative photoresist SU-8, or various embossing resins that are UV or thermally curable, may be used to form the display cell. In other embodiments, the dielectric material 404 of the display cell 400 (or that discussed with respect to FIG. 5) may be made from layers of silicon, or other dielectric materials, using standard techniques for fabricating integrated circuits, such as deposition of dielectric layers and etching of dielectric layers.

The dielectric material 404 may be used to define a first volume 406, which underlies most of the surface area of the display cell 400, as discussed with respect to FIG. 3. One or more recessed volumes 408 may be formed in the dielectric material 404, for example, protruding from the back of the first volume 406, opposite the front surface. The dielectric material 404 forming the different parts of the display cell 400 is not limited to a particular material for all of the components. For example, the dielectric material 404 forming a lowest layer of the display cell 400 may differ from the dielectric material 404 forming the recessed volume 408. The different materials may be selected to ease production of the display cell 404. Further, the recessed volumes 408 do not have to be orthogonal to the first volume 406, but may be at an angle to lower the visibility of particles contained within the second volume 408. Further, each display cell 400 may have numerous recessed volumes 408, as discussed with respect to FIG. 3.

The display cell 400 may be filled with a non-polar carrier fluid 410. The non-polar carrier fluid 410 may be a fluid having a low dielectric constant k, for example less than about 20, and, in some embodiments, less than about 3. In an embodiment, the non-polar carrier fluid 410 may have a dielectric constant of about 2. Generally, the carrier fluid 410 acts as a vehicle for carrying particles 412 and any associated components that may be used for charge stabilization. The use of a low dielectric constant fluid tends to reduce electrostatic screening of the electrodes and, therefore, can increase an electric field present in the fluid when a voltage is applied thereto, It can be clearly understood that when used in a display cell 400, the carrier fluid 410 fills a viewing area defined in the display. The non-polar carrier fluid 410 may include, for example, one or more non-polar solvents selected from hydrocarbons, halogenated or partially halogenated hydrocarbons, oxygenated fluids, siloxanes, and/or silicones. Some specific examples of non-polar solvents include perchloroethylene, halocarbons, cyclohexane, dodecane, mineral oil, isoparaffinic fluids, cyclopentasiloxane, cyclohexasiloxane, and combinations thereof.

In an embodiment, the carrier fluid 410 may include one or more dyes that impart a color to the carrier fluid 410 by absorbing wavelengths that do not contribute to that color. For example, the carrier fluid 410 may include a dye that absorbs or transmits cyan, magenta, yellow, blue, red, green, or any number of other colors. The dye may be dissolved in the carrier fluid 410 or may include uncharged particles of a pigment that are suspended in the carrier fluid 410. Thus, when the charged white (or broadband reflecting) particles 412 are behind the carrier fluid 410, the color of the dye may show, e.g., the wavelengths of light not absorbed by the dye. Such dyes include nonionic azo and anthraquinone dyes, Si phthalocyanine or naphthalocyanine dyes, phthalocyanine, or naphthalocyanine dyes. Examples of useful dyes include, but are not limited to, Oil Red EGN, Sudan Red, Sudan Blue, Oil Blue, Macrolex Blue, Solvent Blue 35, Pylam Spirit Black and Fast Spirit Black from Pylam Products Co., Arizona, Sudan Black B from Aldrich, Thermoplastic Black X-70 from BASF, and anthraquinone blue, anthraquinone yellow 114, anthraquinone reds 111 and 135 and anthraquinone green 28 from Aldrich. Perfluorinated dyes may be used in cases where a fluorinated or perfluorinated dielectric solvent is used. A black dye or dye mixture such as Pylam Spirit Black and Fast Spirit Black from Pylam Products Co., Arizona, Sudan Black B from Aldrich, Thermoplastic-Black X-70 from BASF or a black pigment such as carbon black may be used to generate a black color in the carrier fluid 410.

In an embodiment, the particles 412 are selected from non-absorbing, high refractive index materials, such as titanium dioxide, zinc oxide, aluminum oxides, zirconium dioxide, diamond, and the like. Generally, the scattering intensity increases with the index difference between the particles 412 and the carrier fluid 410. For example, the Rayleigh scattering of light has a fourth order dependence on the difference in refractive index between the material of the particles 412 and the non-polar carrier fluid 410. Accordingly, higher refractive index materials may result in an increase in scattering, for example, of a broad spectrum of light impinging on the display cell 400. The non-polar carrier fluid 410 may often have a refractive index of about 1.5. By comparison, the rutile form of titania has a refractive index of about 2.90, while the anatase form has a refractive index of 2.49, making both forms suitable choices for the particles 412. Other materials may be suitable, despite having a lower refractive index. For example, the particles 412 may be made from zirconia, which has a refractive index of about 2.16, or diamond, which has a refractive index of about 2.42. The particles 412 are not limited to high refractive index materials as other properties such as size may also affect scattering. In embodiments, the size of the particles may be in the nanometer range, for example, from 100 nm to 1000 nm. In an embodiment, the particles may be in the range of about 300 nm±200 nm.

The particles 412 are not limited to the types described above, which tend to scatter a broad spectrum of light and, thus, may appear white when viewed under a white ambient light. In other embodiments, the particles 412 may be made from, or mixed with, solid organic or mineral dyes to provide different colors or color intensities.

In an embodiment, the particles 412 can be charged to enable their motion in the carrier fluid in response to voltages. This may be performed by incorporating charged particles 412 into the carrier fluid 410, for example, in reverse micelles that also incorporate species carrying an opposite charge. Techniques for incorporating charged particles into a non-polar carrier fluid 410 are known to those of skill in the art.

The combinations disclosed herein may have relatively high zeta potentials (e.g., greater than or equal to +20 mV), and thus may be suitable for electro-optical displays, as discussed herein. Such electro-optical displays may include those that are driven by electrophoresis, electro-convective flow, or both. Further, the combinations can be used in displays with in-plane shutter architectures, where the particles 412 are moved laterally into and out of a field of view in the display cell 400.

A transparent first electrode 414 can be incorporated under the transparent layer 402 over the front surface of the display cell 400. In embodiments, the first electrode 414 may be formed from transparent metal oxides, such as indium tin oxide “ITO,” among others. ITO is light transmissive and, thus, allows light to pass through into the display cell 400, to be reflected, and to escape, without being substantially attenuated by the first electrode 414. Thus, the first electrode 414 may allow as much as 50% of the incident light to be reflected back out of the display cell 400. In other embodiments, the first electrode 414 may allow 60%, 70%, 80%, or even more of the light to be reflected back out of the display cell 400. Other materials suitable for use as the first electrode 414 include aluminum oxide, tin oxide, indium oxide, zinc oxide, indium zinc oxide, zinc indium tin oxide, antimony oxide, aluminium doped zinc oxide, and mixtures thereof. The thickness of a first electrode 414 including such an electrically conducting oxide may be greater than about 10 nanometers. In embodiments, the thickness may be in the range of from about 10 nanometers to about 50 nanometers, from about 50 nanometers to about 100 nanometers, or from about 100 nanometers to about 200 nanometers.

In an embodiment, a thin transparent layer of a metal may be used as the first electrode 414. The transparent metal layer may have a thickness of less than or equal to about 50 nanometers. In embodiments, the metal thickness may be in a range of from about 50 nanometers to about 5 nanometers. Suitable metals for the first electrode 414 may include, for example, silver, copper, tungsten, nickel, cobalt, iron, selenium, germanium, gold, platinum, aluminum, carbon, or mixtures thereof or alloys thereof. The metals may have a form of a continuous thin film, a layer of thin film, a network of nanowires, a nanosheet, or a patterned thin film. The first electrode 414 may be deposited on the underlying element by a technique such as physical vapor deposition, chemical vapor deposition, or sputtering.

In embodiments, other materials may be used to create the first electrode 414, including conductive polymers such as a mixed layer of PEDOT (Poly(3,4-ethylenedioxythiophene)) and PSS (poly(styrenesulfonate)). Further, the first electrode 414 can be constructed from networks of carbon nanotubes or other materials. Other materials that may be used to form the first electrode 414 include, for example, polyanaline, and other conducting polymers, and conducting nanofibers and nanostructures.

Similar materials may be used to form a second electrode 416 or a recessed electrode 418. If one or both of these electrodes 416 or 418 are transparent, a color may be applied to the surface of the dielectric 404 behind the second electrode 416 or the recessed electrode 418. For example, a dark or black coating applied behind a transparent second electrode 416 may be visible when the particles 412 are collected in the recessed volume 408. In some embodiments, the second electrode 416 or recessed electrode 418 may be formed from a colored material, such as a dark oxide layer, a graphite layer, or the like. In either case, the second electrode 416 may allow a dark surface to be visible when particles 412 are packed into the recessed volumes 408.

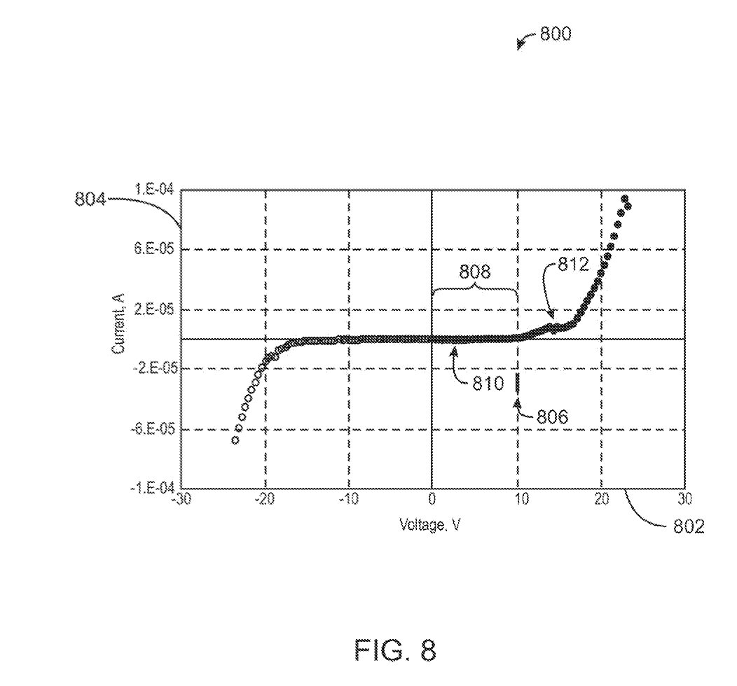

A dielectric switching layer 420 may be applied over each of the first electrode 414, the second electrode 416, or the recessed electrode 418. For example, the dielectric switching layer 420 may be about a 10 nm to 1 μm thick layer of a dielectric material having a thresholding capability, such as a tantalum oxide or other metal oxides. The factor that may control the thickness is the capability of the layer to form a smooth layer without pinholes. As used herein, a thresholding capability indicates that below a certain electric potential, termed a threshold, the dielectric functions as an insulator, while above that threshold, the dielectric may allow the flow of current. The dielectric switching layer 420 may perform as a switch in the display cell 400, allowing current flow at higher imposed potentials, as discussed further with respect to FIG. 8. Many metal oxides may be used as the dielectric switching layer 420, including, for example, aluminum oxide, and hafnium oxide, among others.

The depth 422 of the first volume 406 may be about 5 to 100 μm. The optimal depth 422 may be determined by the tradeoff between switching speed versus color saturation. A shallow cell may have a higher switching speed, but lower color saturation. In an embodiment, the first volume 406 has a depth 422 of about 10 μm. In embodiments, the depth 422 may be about 5 μm, 10 μm, 20 μm, or higher. The depth 424 of the recessed volume 408 may depend on the volume of the particles 412 when packed, as well as the number of recessed volumes 408 within each of the display cells 400. In embodiments, the depth 424 of the recessed volume 408 may be 5 μm, 10 μm, 20 μm, or higher. In an embodiment, the depth 424 of the recessed volume 406 is about 5 μm.

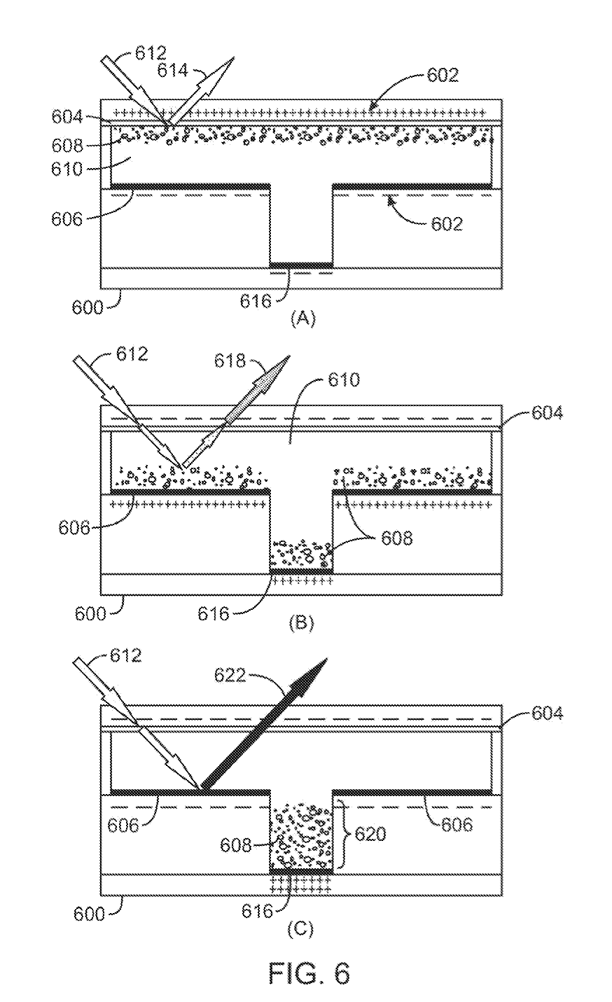

As a result of the structure shown in FIG. 4, the display cell 400 may have three primary optical states, as discussed further with respect to FIG. 6. It can be understood that the three optical states shown in FIG. 6 are end states. However, the particles 412 can be in intermediate states that provide finer control of the color provided. Further, a three-state display cell is not limited to three electrodes, as a two-electrode system may be used to generate three optical states, as discussed herein.

FIG. 5 is a cross section of a two-electrode display cell 500 showing the individual components that may be used in the display cell 500, in accordance with embodiments of the present techniques. The materials are similar to those discussed with respect to FIG. 4. However, as shown in FIG. 5, the second electrode 416 and any thin dielectric layer 420 over the second electrode 416, discussed with respect to FIG. 4, can be eliminated, and replaced with a dark layer 502 on the dielectric 404 opposite the front surface of the display cell 500. The dark layer 502 may be exposed when the particles 412 are in the recessed volumes 408. In the two-electrode display cell 500, the recessed electrode 504 may extend across the display cell MO below the dielectric layer 404 that forms the recessed volumes 408.

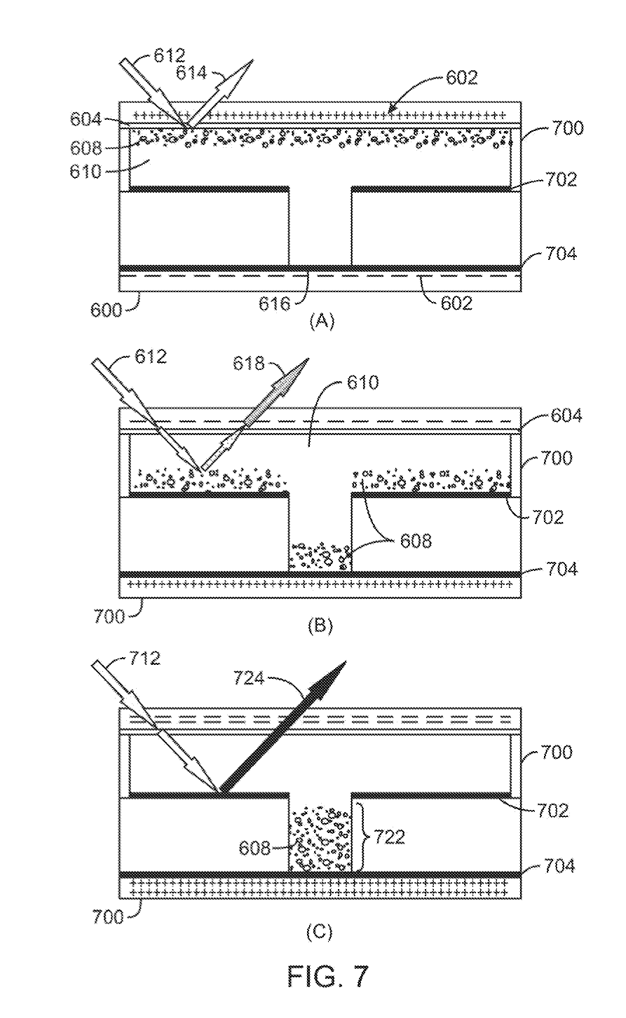

In either of the embodiments of the display cells 400 or 500 discussed above, electrical contacts may be formed into the display cell 400 or 500 to apply an appropriate electric potential to the electrodes 414, 416, 418, and/or 504 when driving the display cell 400 or 500 to produce a selected color. In an example, the electrical contacts may be situated along a side of the display cell 400 or 500, where the electric potential or field is applied to one of the electrodes 414, 416, 418, and/or 504 from a side of the display cell 400 or 500. In another example, electrical connection of at least one of the electrodes 414. 416, 418, and/or 504 may be accomplished using a backplane. The backplane may include, for example, the electrodes configured to drive the display cell 400 or 500 and suitable hardware configured to drive the electrodes. The electrodes may be used to impose an electric potential and/or current that may be used to drive three primary display states, as discussed with respect to FIGS. 6 and 7. In either FIG. 4 or FIG. 5, intermediate display states may be created by moving particles 412 into the carrier fluid 410, without packing the particles 412 against the front surface 414, the dark layer 502, or into the recessed volumes 408.

FIG. 6 is a schematic showing the three primary states of operation of a three-electrode display cell 600, in accordance to an embodiment of the present techniques. A first state is shown in FIG. 6(A). In the first state of operation, a differential voltage 602 may be applied between the front electrode 604 of the display cell 600 and the rear electrode 606 of the display cell 600, for example, with the positive voltage imposed on the front electrode 602. The applied voltage used to create the electrical field is not limited to the front electrode 604 and the rear electrode 606, but may also be applied to the recessed electrode 616. The voltage creates a gradient, or electric field, between electrodes 604, 606, and 616. The gradient created between the electrodes 604, 606, and 616 can cause negatively charged particles 608 suspended in the carrier fluid 610 to move to the front of a display cell 600. As a result, ambient white light 612 impinging on the display cell 600 is reflected back out from the display cell 600 as reflected white light 614. In an embodiment, the voltage applied to the front electrode 604 may match the voltage applied to the rear electrode 606, although different voltages may be applied to obtain different optical states.

In a second state, shown in FIG. 6(B), the polarity of the voltage applied to the electrodes 604, 606, and 616 is reversed, causing negatively charged particles 608 to move to the back of the display cell 600. Again, the voltage applied to the rear electrode 606 may be applied to the recessed electrode 616. As a result of the particles 608 being located at the back of the display cell 600, ambient white light 612 passes through the colored carrier fluid 610, reflects off the particles 608 at the back of the display cell 600, and exits the display cell 600 as colored light 618.

In a third state, shown in FIG. 6(C), a stronger positive potential may be applied to the recessed electrode 616, while a negative voltage is applied to both the front electrode 604 and the rear electrode 606. This may move the particles 608 into the recessed volume 620, exposing the rear electrode 606. If the rear electrode 606 is black, ambient white light 612 can be absorbed, making the display cell 600 appear to be black 622. Various other voltage gradients may be used for example, to move the particles to positions in-between the electrodes, forming optical states of intermediate color intensity.

The voltage applied to the display cell 600 in this case may be above a switching, or threshold, voltage of a dielectric switching layer over the electrodes 604, 606, and 616, as discussed with respect to FIG. 4. This may cause an electric current flow from the front electrode 604 and the rear electrode 606 to the recessed electrode 616. In turn, the flow of electric current may cause convective motion of the carrier fluid. Thus, the particles 608 may be moved by both the imposed electrical field (which may be termed electrophoretic motion) and the fluid flow (which may be termed electro convective motion). The current flow may improve the switching time for moving from either the first state (FIG. 6(A)) or the second state (FIG. 6(B)) to the third state (FIG. 6(C)). The dielectric switching is discussed further with respect to FIG. 8.

The display cell 600 may be multistable, for example, with the particles 608 remaining in the last state when the applied voltage is removed. However, some drift may occur from Brownian motion and/or convection currents, especially in the case of larger display cells 600. Accordingly, a voltage, for example, about 1 to 10 V, may be continuously imposed to hold the particles 608 in place. In embodiments, a voltage of about 3 V may be used to hold the particles in place. The three primary states of operation are not limited to three-electrode display cells 600, but may also be performed using two-electrode display cells.

FIG. 7 is a schematic showing the three primary states of operation of a two-electrode display cell 700, in accordance to an embodiment of the present techniques. Similar to the three-electrode embodiment shown in FIG. 6, the two electrode embodiment may move particles 608 to the front or back of the display cell 700 by imposing electric potentials that cause electrophoretic motion, as shown in FIGS. 7(A) and 7(B). In this case, the electric fields are imposed between the first electrode 604 and a back electrode 704. The imposition of a higher electric potential, as shown in FIG. 7(C) may cause the particles 608 to move into a recessed volume 722 by a combination of electrophoretic and electroconvective motion. The difference between the states of operation shown in FIGS. 7(A) or 7(B) and the state of operation shown in FIG. 7(C) may be enhanced by the switching layer of dielectric, as discussed with respect to FIG. 8.

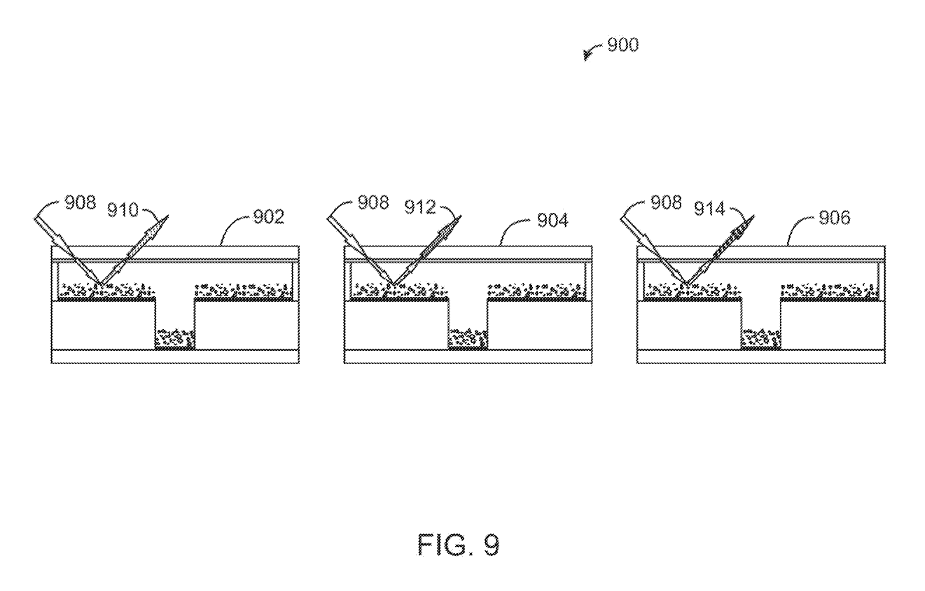

FIG. 8 is a graph 800 illustrating the use of a dielectric switching layer that may be used to drive a display cell in accordance with an embodiment of the present techniques. In the graph 800, the x-axis 802 represents the voltage applied between two electrodes of a display cell and the y-axis 804 represents the current flow that results. Below a threshold voltage level 806, for example, shown as 10 v in the graph, an electric field may be imposed on the display cell, but minimal current flow occurs, for example, the dielectric switching layer may function as an insulator. This range 808 may generally be used either for the first and second display states discussed with respect to FIGS. 6(A) and 6(B), 7(A) and 7(8), or for holding particles in place. Thus, applying a voltage 806 of about 8-10 v may cause particle motion through applied electric fields (electrophoretic motion), without current flow in the display cell depending on the thickness of nonlinear resistor layer. Further, applying a voltage 810 of about 1-3 v may hold the particles in place against motion caused by convection currents or Brownian motion. By comparison, applying a higher voltage 812, for example, about 14 v, may cause the dielectric switching layer to switch to a conducting state and allow a current to flow, resulting in both electrophoretic motion and electroconvective motion. As mentioned above, the display cells may be used as a pixel or a sub-pixel part of a larger system. This is more clearly seen with respect to FIG. 9.

FIG. 9 is a schematic of a pixel 900 in which each of three adjoining display cells functions as a sub-pixel 902, 904, or 906 in the pixel 900, in accordance to an embodiment of the present techniques. Either the three electrode display cell 400 (FIG. 4) or the two electrode display cell 500 (FIG. 5), may be used as the sub-pixels 902, 904, and 906. In the pixel 900, a first sub-pixel 902 may be a display cell in which the carrier fluid contains a red dye. The second sub-pixel 904 may be a display cell in which the carrier fluid contains a green dye, and the third sub-pixel 906 may be a display cell in which the carrier fluid contains a blue dye. As would be clear to one of ordinary skill in the art, the color of the dye corresponds to light transmitted through the dye. Further, the colorants can consist not only of additive colorants but also of subtractive colorants, and combinations thereof.

In this example, all three of the display cells are in the second state, as discussed with respect to FIGS. 6(B) or 7(B), and, thus, the reflected color corresponds to the dye color. For example, white light 908 impinging on the first sub-pixel 902 reflects as red light 910, while white light 908 impinging on the second sub-pixel 904 reflects as green light 912, and white light 908 impinging on the third sub-pixel 906 reflects as blue light 914. Although, it can be recognized that the total reflected light from this state is white, the total intensity may be low, providing a somewhat grayish white.

However, in embodiments of the present techniques, the display cells each have three states, as discussed above. Therefore, the sub-pixels 902, 904, and 906 may create a pixel 900 that has twenty-seven base states, even without partial movement of the particles. It will be clear that a number of these optical states may overlap. For example, white may be created by having all particles at the front of the sub-pixels 902, 904, and 906, but may also be created, albeit in a dimmer display, by having the particles at the back of the sub-pixels 902, 904, and 906. Accordingly, the pixel may provide a much brighter white color by having all three sub-pixels 902, 904, and 906 in the first state, discussed with respect to FIGS. 6(A) or 7(A). The possibility of combining states may also allow the tone or brightness of a color to be controlled, for example, by using some of the displays cells in the first or third states. The display cells of the present techniques may be used in any number of applications where the low power usage and ease of modification of displayed material are an advantage, as discussed with respect to FIGS. 10-14, below.

FIG. 10 is a mobile phone 1000 having a skin 1002, or surface display, which uses three state display cells, in accordance with embodiments of the present techniques. The skin 1002 may be customized by displaying graphics 1004 or text using a segmented or pixelated display formed of display cells. The skin 1002 may be reconfigured, for example, by the user, to customize the graphics. As a display state in the display cells may be held with low power consumption, the skin 1002 can provide customized graphics without substantially shortening battery life. For example, the battery life may be within 1%, 5%, or 10% of the battery life without the skin 1002. Further battery life may be achieved if the display cells are multi-stable, for example, by keeping the display cells small to minimize convection currents and Brownian motion.

FIG. 11 is a sign 1100 that uses display cells to display information on a background 1102, in accordance with an embodiment of the present techniques. The sign 1100 may use a segmented display in which the text characters 1104 and/or the graphical elements 1106 are made up of relatively large display pixels and, thus, are of a fixed design. In embodiments, the background 1102 may be pixelated, allowing the text 1104 and graphical elements 1106 of the sign to be completely configurable. The low power demand may allow the sign to be used in retail applications that do not have convenient line power, for example, using a battery or capacitor to provide the holding charge. The sign 1100 may be a point-of-purchase sign, a larger display, such as a restaurant menu, or a large outdoor sign, such as at a bus stop.

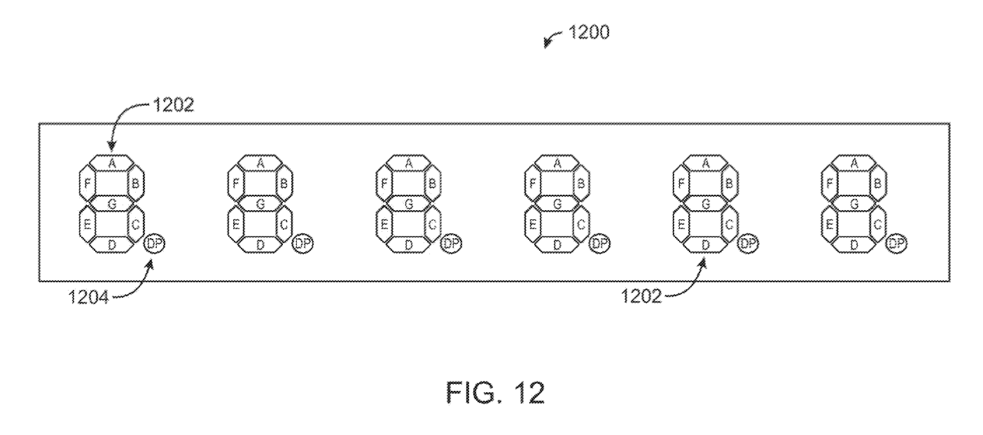

FIG. 12 is an illustration of a segmented display 1200 that may use display cells as the segments, in accordance with an embodiment of the present techniques. Such a display may provide a color display for pricing information or quotes. In embodiments, each of the display elements, such as segments 1202 or decimal points 1204, may be made up of a single display cell or a single pixel. However, the use of larger display cells may allow the particles to settle out, especially at times when a holding field is not applied to the display 1200. Accordingly, each of the display elements may be made up a number of smaller display cells that are connected to be controlled together.

FIG. 13 is a shelf pricing tag 1300 that may be made of display cells, in accordance with an embodiment of the present techniques. The shelf pricing tag 1300 may have regions that are pixelated for the display of text 1302 or graphic elements and other regions that are segmented for the display of numbers 1304. The shelf pricing tag 1300 may be used in conjunction with a microprocessor and an inventory system to automatically display information that corresponds to items on an adjacent shelf. Further, the shelf pricing tag 1300 may display calculated information to assist consumers, such as package weight 1306 and per unit pricing 1308. These values may be calculated once when the system detects a stocking change, then held using low power consumption, until a next stocking change.

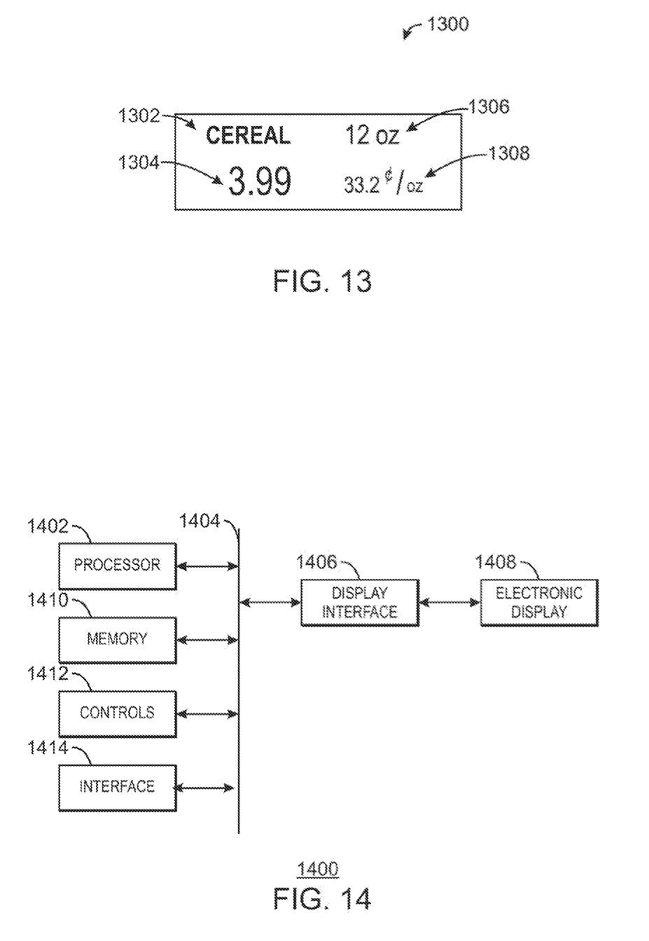

FIG. 14 is a block diagram of an electronic device 1400 that uses an electro-optical display made of display cells, in accordance with embodiments of the present techniques. The electronic device either may use a pixelated display, such as the electronic display device of FIG. 1, or may use a segmented display, such as the shelf pricing tag of FIG. 11. The electronic device may have a processor 1402 coupled to a number of operational units by a bus 1404. The operational units may include a display interface 1406, which may drive an electro-optical display 1408, as discussed herein.

A memory 1410 may be coupled to the processor 1402 through the bus 1404. The memory 1410 may include, for example, a random access memory (RAM), a read only memory (ROM), a RAM disk, a hard drive, or any other type of non-transitory computer readable medium. The memory 1410 may comprise code and information configured to direct the processor 1402 to display data on an electro-optical display 1408 that uses display cells with three optical states, as described herein. The memory 1410 may also include content to be displayed, such as books, sign information, and the like. Further, the memory 1410 may include code configured to direct the processor to access controls 1412 in order to accept and act on user input, such as a request to access a vendor through an interface 1414 and download a text to the electronic device.

What is claimed is:

1. A tri-state electro-optical display (106) comprising:
a plurality of display cells (300, 400, 500), wherein each of the plurality of display cells (300, 400, 500) comprises:
a first electrode (414), wherein the first electrode (414) comprises a transparent electrode disposed over a front surface of a display cell (300, 400, 500);
a second electrode (418, 504) disposed opposite the first electrode;
a dielectric layer (404) disposed between the first electrode (414) and the second electrode (418, 504), wherein the dielectric layer (404) is patterned to create a plurality of recessed volumes (302, 408);
a fluid (410) disposed in a volume (406, 408) defined by the first electrode (414), the dielectric layer (404), and the recessed volumes (302, 408), wherein the fluid (410) comprises a dye of a different color from an adjacent one of the plurality of display cells; and
a plurality of charged particles (412) disposed within the fluid (410); and
a display interface (1406) configured to pack the plurality of charged particles (412) against the front of the display cell (300, 400, 500) to create a first optical state, to pack the plurality of charged particles (412) against the back of the display cell (300, 400, 500) to create a second optical state, or to pack the plurality of charged particles (412) into the recessed regions (408) to create a third optical state.

2. The tri-state electro-optical display of claim 1, wherein a display cell (300, 400, 500) comprises a dielectric switching layer (420) disposed over the first electrode (414) or the second electrode (418, 504), or both, wherein the dielectric switching layer (420) is configured to switch from a non-conducting state to a conducting state when an applied voltage (802) exceeds a threshold level (806).

3. The tri-state electro-optical display of claim 1, wherein a display cell (300, 500) comprises a third electrode (416) opposed to the first electrode (414) and formed over the dielectric layer (404), outside of the plurality of recessed volumes (408).

4. The tri-state electro-optical display of claim 3, wherein the display interface (1406) is configured to pack the plurality of charged particles (412) against the third electrode (416) when a differential voltage is applied between the first electrode (414) and the third electrode (416).

5. The tri-state electro-optical display of claim 1, wherein an aperture (306) of the plurality of recessed volumes (302, 408) does not substantially affect the optical contrast of the display cell (300).

6. The tri-state electro-optical display of claim 1, comprising an electrode (418) formed at the bottom of each of the plurality of recessed volumes (302, 408).

7. A method for operating a display cell (300, 400, 500), comprising:
applying a first voltage to a plurality of electrodes (414, 416, 418, 504) in a display cell (300, 400, 500) to form a first optical state in which a plurality of charged particles (414) are packed against a front surface of the display cell (300, 400, 500);
applying a second voltage to the plurality of electrodes (414, 416, 418, 504) in the display cell (300, 400, 500) to form a second optical state in which the plurality of charged particles (412) are packed against a back surface of the display cell; and
applying a third voltage to the plurality of electrodes (414, 416, 418, 504) to form a third optical state in which the plurality of charged particles (412) are packed inside a plurality of recessed volumes (408) in a dielectric (404);
wherein the display cell (300, 400, 500) comprises:
a first electrode (414), wherein the first electrode (414) comprises a transparent electrode disposed over a front surface of a display cell (300, 400, 500);
a second electrode (418, 504) disposed opposite the first electrode (414);
a dielectric layer (404) disposed between the first electrode (414) and the second electrode (418, 504), wherein the dielectric layer (404) is patterned to create a plurality of recessed volumes (406);
a fluid disposed in a volume defined by the first electrode, the dielectric layer, and the recessed volumes; and
the plurality of charged particles is disposed within the fluid.

8. The method of claim 7, comprising operating a plurality of adjacent display cells (902, 904, 906) as a single pixel (900).

9. The method of claim 7, comprising:
displaying a first set of information using display cells (300, 400, 500) operating in the first optical state and the third optical state; and
displaying a second set of information using display cells (300, 400, 500) operating in the second optical state and either the first optical state or the third optical state.

10. An electronic device (1400), comprising:
a processor (1402);
a display (1408) comprising a plurality of display cells (300, 400, 500),
wherein each of the plurality of display cells (300, 400, 500) comprises:
a first electrode (414), wherein the first electrode (414) comprises a transparent electrode disposed over a front surface of a display cell (300, 400, 500);
a second electrode (418, 504) disposed opposite the first electrode;
a dielectric layer (404) disposed between the first electrode (414) and the second electrode (418, 504), wherein the dielectric layer (404) is patterned to create a plurality of recessed volumes (302, 408);
a fluid (410) disposed in a volume (406, 408) defined by the first electrode (414), the dielectric layer (404), and the recessed volumes (408); and
a plurality of charged particles (412) disposed within the fluid (410); and
a display interface (1406) configured to pack the plurality of charged particles (412) against the front of the display cell (300, 400, 500) to create a first optical state, to pack the plurality of charged particles (412) against the back of the display cell (300, 400, 500) to create a second optical state, or to pack the plurality of charged particles (412) into the recessed regions (408) to create a third optical state; and
a memory (1410), wherein the memory (1410) comprises code configured to direct the processor (1402) to control the display interface (1406) so as to display data on the display (106, 1408).

11. The electronic device of claim 10, wherein the fluid (410) in the display cell (300, 400, 500) comprises a dye of a different color from at least one adjacent display cell (300, 400, 500).

12. The electronic device of claim 10, comprising a pixel (900) comprising three adjoining display cells (902, 904, 906), in which a first adjoining display cell (902) comprises a red dye, a second adjoining display cell (904) comprises a green dye, and a third adjoining display cell (906) comprises a blue dye.

13. The electronic device (1400) of claim 10, wherein each of the plurality of display cells (300, 400, 500) comprises at least a portion of a display element (1202, 1204) in a segmented display (1200).

14. The electronic device (1400) of claim 10, comprising an electronic book reader (100).

15. The electronic device (1400) of claim 10, comprising a shelf tag (1300), a skin (1002) for an electronic device (1000), a sign (1100), a price display, or any combinations thereof.
